(19) United States
(12) Patent Application Publication
(10) Pub. No.: US 2015/0261893 A1
(43) Pub. Date: Sep. 17, 2015

(54) METHOD AND APPARATUS FOR DETERMINING PIPELINE FLOW STATUS PARAMETER OF NATURAL GAS PIPELINE NETWORK

(71) Applicant: CHINA UNIVERSITY OF PETROLEUM - BEIJING, BEIJING (CN)

(72) Inventors: BO YU, BEIJING (CN); PENG WANG, BEIJING (CN); KAIFENG YANG, BEIJING (CN)

(21) Appl. No.: 14/616,486

(22) Filed: Feb. 6, 2015

(30) Foreign Application Priority Data
Apr. 22, 2014 (CN) 201410163421.6

(51) Int. Cl. G06F 17/50; G06F 17/10

(52) U.S. Cl. CPC G06F 17/5004; G06F 17/10

(57) ABSTRACT

The present invention provides a method and apparatus for determining pipeline-flow status parameters of natural-gas-pipeline network, the method includes: dividing natural-gas-pipeline network into multiple areas according to its topology structure; for each area, establishing first control equation representing operating status in pipelines of the area, of which unknown parameters are pipeline-flow status parameters in the pipelines of the area, known parameters include structural parameters of pipelines, operating parameters of components and physical-property parameters of natural gas; for each area, establishing second control equation representing operating status at boundary nodes of the area; solving the first and second control equation to determine the pipeline-flow status parameters in the pipelines and at the boundary nodes of each area. In the present invention, algebraic equation set with fewer equations is solved, thereby achieving high efficient and rapid calculation of the pipeline-flow status parameters of the natural-gas-pipeline network, which is easy to operate.

### CROSS-REFERENCE TO RELATED APPLICATIONS

This application claims priority to Chinese Patent Application No. 201410163421.6, filed on Apr. 22, 2014, entitled “Method and Apparatus for Determining Pipeline Flow Status Parameter of Natural Gas Pipeline Network”, which is incorporated herein by reference in its entirety.

### TECHNICAL FIELD

The present invention relates to the field of natural gas transportation technology and, in particular, relates to a method and an apparatus for determining pipeline flow status parameter of a natural gas pipeline network.

### BACKGROUND

Natural gas is a clean and high-efficient fossil energy source, and its development and utilization has attracted more and more attention. During the period of “Eleventh Five-Year Plan”, China's natural gas industry has developed rapidly. According to statistics, by the end of year 2010, total length of natural gas pipelines has reached 40,000 kilometers, natural gas usage amount has reached 107 billion cubic meters per year, and it is expected that the natural gas usage amount will reach 260 billion cubic meters per year at the end of “Twelfth Five-Year Plan”. In order to ensure smooth scheduling of natural gas, China has built up a plurality of modernized natural gas pipelines with large diameter, high pressure tolerance, long pipeline and high flow tolerance, such as West-to-East gas transmission pipeline I and II, Sichuan-to-East gas pipeline, Shaanxi-Beijing gas pipeline and so on. It is an inevitable trend of the natural gas industry development in China that these main pipelines are connected to form a pipeline network.

Natural gas pipeline network (the natural gas pipeline network is a network structure formed by interconnecting pipelines for transmitting natural gas) simulation is an essential technology for guaranteeing safe operation of the pipelines. Computer simulation of the natural gas pipeline network is to acquire pipeline flow status parameters in the pipeline such as pressure, temperature, and flow rate of the pipeline, by solving a control equation (the control equation is a partial differential equation for describing operation of the natural gas in the pipeline, including continuity equation, momentum equation and energy equation) using numerical method. During computer simulation of the natural gas pipeline network, since the control equation is a partial differential equation, it is very difficult or even impossible to obtain the analytical solution directly. In an engineering process, it is often to adopt a numerical method, the specific solving process can be divided into 5 steps as follows:

1. Discretizing computation domain after establishing a control equation of the whole pipeline network: first, dividing the computation domain into multiple subsections, that is, dividing each pipeline into multiple subsections, wherein a short element such as a compressor and a valve can be regarded as a subsection.

2. Discretizing the control equation: for each of the subsections, discretizing the control equation into algebraic equations that can be solved directly, by using a certain discretization format.

3. Supplementing boundary conditions: establishing algebraic equations for boundary nodes outside the pipeline network.

4. Solving equations by a computer: establishing simultaneous equations composed of above algebraic equations and solving the simultaneous equations via a computer so as to acquire arithmetic solutions (using a plurality of discrete values to replace a continuously varying solution).

5. Presenting results: drawing a graph according to the arithmetic solutions so as to describe and analyze pipeline flow status parameters inside the pipeline.

In above step 4, the computer solving process is a process of solving the discrete algebraic equations using a computer. After the control equation is discretized into the algebraic equation, the algebraic equation should be written into the computer in form of a matrix, the computer processes the matrix to accomplish solution of the algebraic equation. Since the natural gas pipeline network is complicated (there are many components in the pipeline network, the pipeline is long and there are a great variety of network structures) and handling of the pipeline network as a whole will result in that the number of the algebraic equations is huge. Therefore, when handling matrices of the whole pipeline network, time consumption of the computer and square of the number of the algebraic equations represent a linear relationship (for example, A and B represent a linear relationship, wherein if A increases (decreases), B will proportionally increase (decrease)), which will occupy a lot of computer memory and lead to slow running speed of the computer. When the scale of the pipeline network as well as the complexity thereof increases, the time consumption of the computer will increase rapidly.

During computer solving process, although sparse matrix storage mode is generally adopted for acceleration, implementation of the sparse matrix storage mode is really complicated. Moreover, since there are lots of uncontrollable factors which affect the acceleration effect, in some extreme situations, using the sparse matrix storage mode may not achieve a good effect.

### SUMMARY

Embodiments of the present invention provide a method and an apparatus for determining pipeline flow status parameters of a natural gas pipeline network, which solves the technical problem of poor speed of natural gas pipeline network simulation in the prior art.

Embodiments of the present invention provide a method for determining pipeline flow status parameters of a natural gas pipeline network, the method includes: dividing a natural gas pipeline network into a plurality of areas according to topology structure of the natural gas pipeline network; for each area, establishing a first control equation representing the operating status in pipelines of the area, wherein unknown parameters of the first control equation are pipeline flow status parameters in the pipelines of the area, and known parameters of the first control equation include structural parameters of the pipelines of that area, operating parameters of components and physical property parameters of natural gas; for each area, establishing a second control equation representing operating status at boundary nodes of the area, wherein unknown parameters of the second control equation are pipeline flow status parameters at the boundary nodes of the area, the boundary nodes of the area are connection points of the area connecting with adjacent areas in the natural gas pipeline network; solving the first control equation and the second control equation, to determine the pipeline flow status parameters in the pipelines of each area and at the boundary nodes of each area.

Before solving the first control equation of each area, the method further includes: linearizing the first control equation for each area; and discretizing computation domain of each area into multiple sections, and discretizing the linearized first control equation for each area as an algebraic equation set on the sections, coefficient matrix of the algebraic equation set of each area is a matrix with a preset rule.

In an embodiment, solving the first control equation and the second control equation to determine the pipeline flow status parameters in the pipelines of each area and at the boundary nodes of each area includes: solving the algebraic equation set of each area to acquire the fundamental solution system and general solutions of the algebraic equation set for each area; for each area, analyzing the fundamental solution system for the area to acquire a linear relationship between the pipeline flow status parameters at the boundary nodes of the area and fundamental variables for the area, wherein the fundamental variables for the area are variables represented by the coefficient that is multiplied when the fundamental solution system of the area representing the general solution for the area; calculating values of the fundamental variables of all areas using the second control equations of all areas and using the linear relationship between pipeline flow status parameters at the boundary nodes of all areas and the fundamental variables, and determining the values of the fundamental variables for each area as numerical solutions of the pipeline flow status parameters at the boundary nodes of the area; determining the numerical solutions of the pipeline flow status parameters in the pipelines of each area according to the numerical solutions, the fundamental solution system and the general solutions of the fundamental variables for each area.

In an embodiment, the pipeline flow status parameters in the pipelines of each area include: pressure, flux, temperature, flowing speed and density in the pipeline; the pipeline flow status parameters at the boundary nodes of each area include: pressure, flux, temperature, flowing speed and density in the pipeline.

Embodiments of the present invention further provide an apparatus for determining pipeline flow status parameters of a natural gas pipeline network, the apparatus includes: a dividing module configured to divide the natural gas pipeline network into a plurality of areas according to topology structure of the natural gas pipeline network; a first equation establishing module configured to, for each area, establish a first control equation representing operating status in pipelines of the area, wherein unknown parameters of the first control equation are pipeline flow status parameters in the pipelines of the area, and known parameters of the first control equation include structural parameters of the pipelines, operating parameters of components and physical property parameters of natural gas; a second equation establishing module, configured to, for each area, establish a second control equation representing operating status at boundary nodes of the area, wherein unknown parameters of the second control equation are pipeline flow status parameters at the boundary nodes of the area, the boundary nodes of the area are connection points of the area connecting with adjacent areas in the natural gas pipeline network; a solving module, configured to solve the first control equation and the second control equation, so as to determine the pipeline flow status parameters in the pipelines of each area and at the boundary nodes of each area.

In an embodiment, the apparatus further includes: a linearizing module, configured to linearize the first control equation of each area before solving the first control equation for each area; a discretizing module, configured to discretize computation domain of each area into multiple sections, and discretize the linearized first control equation for each area as an algebraic equation set on the sections, coefficient matrix of the algebraic equation set of each area is a matrix with a preset rule.

In an embodiment, the solving module includes: a first unit, configured to solve the algebraic equation set for each area, and thus acquire the fundamental solution system and general solutions of the algebraic equation set for each area; a linear analyzing unit, configured to, for each area, analyze the fundamental solution system for the area, and thus acquire a linear relationship between pipeline flow status parameters at boundary nodes of the area and fundamental variables for the area, wherein the boundary nodes of the area are connection points of the area connecting with adjacent areas in the natural gas pipeline network, and the fundamental variables of the area are variables represented by the coefficient that is multiplied when the fundamental solution system of the area representing the general solution for the area; a second unit, configured to calculate values of the fundamental variables of every area using the simultaneous second control equations of all areas, and using the linear relationship between pipeline flow status parameters at the boundary nodes of every area and the fundamental variables for the area, and determine the values of the fundamental variables of each area as numerical solutions of the pipeline flow status parameters at the boundary nodes of the area; a third unit, configured to determine the numerical solutions of the pipeline flow status parameters in the pipelines of each area according to the numerical solutions, the fundamental solution system and the general solutions of the fundamental variables for each area.

In an embodiment, the pipeline flow status parameters in the pipelines of each area include: pressure, flux, temperature, flowing speed and density in the pipeline; and the pipeline flow status parameters at the boundary nodes of each area include: pressure, flux, temperature, flowing speed and density in the pipeline.

In embodiments of the present invention, the natural gas pipeline network is divided into a plurality of areas according to the topology structure of the natural gas pipeline network, and for each area, a first control equation independently representing operating status of natural gas in pipelines of the area, and a second control equation representing the operating status at boundary nodes of the area are established, and then, the first and second control equations are solved, to determine pipeline flow status parameters in the pipelines of each area and those at the boundary nodes of each area, and thus acquire the pipeline flow status parameters of the whole natural gas pipeline network. Through dividing the natural gas pipeline network into a plurality of areas, and for each area, establishing a second control equation representing operating status at boundary nodes of the area and a first control equation independently representing operating status in the pipelines of the area, it is only necessary to solve all simultaneous second control equations (the number of unknown parameters is only 4 times of the number of the divided areas, which is much less than the number of unknown parameters of the first control equation for any area), and the first control equation for each area can be solved independently, during solving process, thereby achieving that during solving process of the first and second control equations, only an algebraic equation set with a relative small number of algebraic equations needs to be solved after the control equations are discretized as the algebraic equation set. Therefore, the solving process on an algebraic equation set with a huge number of equations when the natural gas pipeline network is regarded as a whole, is avoided. Meanwhile, the algebraic equation sets for areas are mutually independent and can be solved in parallel, thereby achieving a high efficient and rapid calculation of pipeline flow status parameters of the natural gas pipeline network, which is easy to operate and can significantly improve the speed of the natural gas pipeline network simulation.

### BRIEF DESCRIPTION OF DRAWINGS

The drawings described herein below are provided for further understanding of the present invention, and constitute a part of the present application, but are not intended to limit the present invention. In the drawings:

FIG. 1 is a flow diagram of a method for determining pipeline flow status parameters of natural gas pipeline network according to an embodiment of the present invention; and

FIG. 2 is a schematic structural block diagram of an apparatus for determining pipeline flow status parameters of natural gas pipeline network according to an embodiment of the present invention.

### DESCRIPTION OF EMBODIMENTS

To make the objectives, technical solutions, and advantages of the present invention more clear, the present invention is further described in detail below with reference to the accompanying drawings and embodiments. Here, the exemplary embodiments of the present invention and the descriptions thereof are adopted to explain the present invention without limiting the present invention.

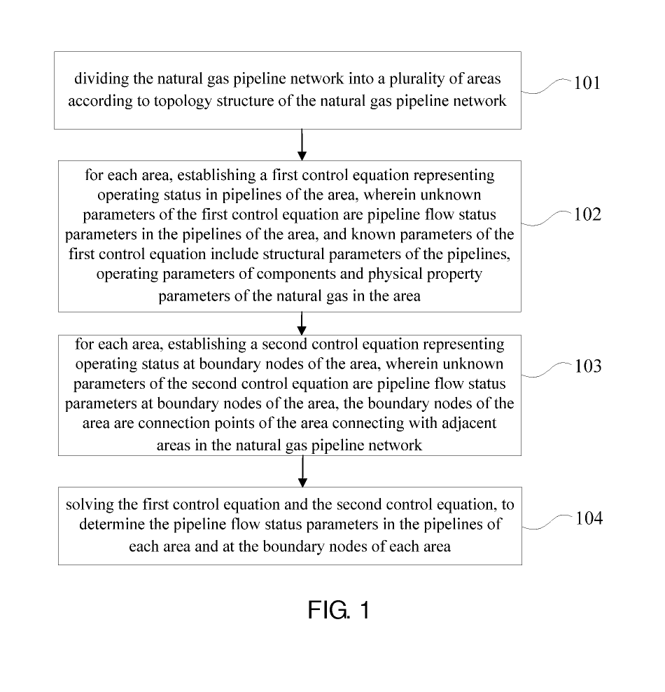

In embodiments of the present invention, a method for determining pipeline flow status parameters of a natural gas pipeline network is provided, as shown in FIG. 1, the method includes:

Step 101: dividing the natural gas pipeline network into a plurality of areas according topology structure of the natural gas pipeline network;

Step 102: for each area, establishing a first control equation representing operating status in pipelines of the area, wherein unknown parameters of the first control equation are pipeline flow status parameters in the pipelines of the area, and known parameters of the first control equation include structural parameters of the pipeline, operating parameters of components and physical property parameters of natural gas in the area; and the first control equation represents inter-relationship among pipeline flow status parameters of each part in the pipelines of the area.

Step 103: for each area, establishing a second control equation representing operating status at boundary nodes of the area, wherein unknown parameters of the second control equation are pipeline flow status parameters at the boundary nodes of the area, the boundary nodes of the area are connection points of the area connecting with adjacent areas in the natural gas pipeline network; and the second control equation represents inter-relationship among the boundary nodes of the area and the boundary nodes of adjacent areas.

Step 104: solving the first control equation and the second control equation, to determine pipeline flow status parameters in the pipelines of each area and at the boundary nodes of each area.

It can be seen from the flow diagram shown in FIG. 1 that, in embodiments of the present invention, the natural gas pipeline network is divided into a plurality of areas according to topology structure of the natural gas pipeline network. For each area, a first control equation (for example, pipeline flow equation, continuity equation, momentum equation and energy equation), which independently represents operating status of natural gas in pipelines of the area, is established, and a second control equation (for example, flow balance equation: in the pipeline network, total inflow mass of connection points equals to total outflow mass thereof; pressure equality equation: in the network, pressures of components connecting to the same connection point are equal at that point; energy balance equation: in the pipeline network, total inflow energy at the connection points equals to total outflow energy thereof), which represents operating status at boundary nodes of the area, is established. Then, the first and second control equations of all areas are solved, so as to determine pipeline flow status parameters in the pipelines of each area and at the boundary nodes of each area, and thus acquire complete pipeline flow status parameters of the natural gas pipeline network. Through dividing the natural gas pipeline network into a plurality of areas, and for each area, establishing a second control equation representing operating status at boundary nodes of the area and a first control equation independently representing operating status of natural gas in the pipelines of the area, it is only necessary to solve all simultaneous second control equations (the number of unknown parameters is only 4 times of the number of the divided areas, which is much less than the number of unknown parameters of the first control equation for any area) during solving process, and the first control equations for each area can be solved independently, thereby achieving that during solving process of the first and second control equations for each area, only an algebraic equation set with a relative small number of algebraic equations needs to be solved after the control equations are discretized as the algebraic equation set. Therefore, the solving process on an algebraic equation set with a huge number of equations when the natural gas pipeline network is regarded as a whole, is avoided. Meanwhile, the algebraic equations sets for areas are mutually independent and can be solved in parallel, thereby achieving a high efficient and rapid calculation of pipeline flow status parameters of the natural gas pipeline network, which is simple and practicable. In particular, for those natural gas pipeline networks having a large scale and high complexity, the speed of the natural gas pipeline network simulation can be significantly improved.

In a specific implementation mode, elements included in each area can be compressors, valves, etc., operating parameters of the elements can be power, opening, etc., pipeline structural parameters can be diameter, length of pipeline, etc., and physical property parameters of natural gas can be density, temperature of natural gas, etc.

In specific implementation, in order to further improve calculation speed, in the present embodiment, the first control equation for each area is discretized as an algebraic equation set, for example, by the following steps: before solving the first control equation of each area, linearizing the first control equation of each area, and discretizing computation domains of each area to a plurality of subsections, for example, dividing a pipeline into a plurality of subsections, wherein short components such as compressors and valves can be regarded as separate subsections; discretizing the linearized first control equation for each area as an algebraic equation set on the subsection, coefficient matrix of the algebraic equation set for each area is a matrix with a preset rule. That is, through linearizing the first control equation for each area, so that the coefficient matrix of the algebraic equation set for each area is a matrix in a specific form, for example, a matrix in a tridiagonal form. Thus, a matrix processing method having high efficiency and speed can be adopted to solve the algebraic equation set, avoiding the situation where, due to mathematical characteristics of the directly discretized algebraic equation set, the coefficient matrix of the directly discretized algebraic equation set is in disorder, cannot be partitioned and has few non-zero elements, thus, only general matrix processing method with slow calculation speed can be adopted rather than the high efficient and rapid matrix processing method.

In specific implementation, the following steps can be used to solve the first and second equations for all areas: determining pipeline flow status parameters in the pipeline of each area and at boundary nodes of each area, for example, by solving the algebraic equation set for each area to acquire fundamental solution system (vectors which can linearly combine any set of solutions of a homogeneous linear equation set) and general solution (a set of solution which is the most fundamental one without multiplying a coefficient in a homogeneous linear equation set) of the algebraic equation set for each area; since the necessary condition for solving the first control equation is to know the pipeline flow status parameters at boundary nodes of the area, which is the unknown parameters for the second control equation, and the necessary condition for solving the second control equation is to know the relationship among different pipeline flow status parameters at different boundary nodes of the area, therefore, in order to acquire a numerical solution of the first control equation for each area, it is needed to analyze the fundamental solution system for the area and acquire the linear relationship between the pipeline flow status parameters at boundary nodes of the area and a fundamental variable for the area, wherein the fundamental variables for the area are variables represented by the coefficient that is multiplied when the fundamental solution system for the area representing the general solution for the area (for example, the variable represented by the multiplied coefficient can be pressure value or flux value, etc. at boundary nodes); then calculating values of the fundamental variables for all areas simultaneously by using simultaneous second control equations for all areas, and using the linear relationship between pipeline flow status parameters at boundary nodes of all areas and values of the corresponding fundamental variables, and the values of the fundamental variables for each area are determined as numerical solutions of the pipeline flow status parameters at boundary nodes of the area; determining the numerical solutions of the pipeline flow status parameters in the pipeline of each area (using multiple discrete values to replace a continuously changing solution) according to the numerical solutions, the fundamental solution system and the general solutions of the fundamental variables for each area. That is, complete pipeline flow status parameters of the whole natural gas pipeline network are acquired by the following steps: first determining the linear relationship between pipeline flow status parameters at boundary nodes of each area and fundamental variables of the area through decomposition of the first control equation for the area, and then solving simultaneous second control equations for all areas to determine pipeline flow status parameters at boundary nodes of all areas simultaneously, and finally acquiring pipeline flow status parameters in pipelines of each area.

In specific implementation, numerical solutions of pipeline flow status parameters of natural gas operating in pipelines of each area and values of pipeline flow status parameters of natural gas operating at boundary nodes of each area can be shown in the form of graph or data.

In specific implementation, the pipeline flow status parameters in pipelines of each area include: pressure, flux, temperature, flowing speed and density of the pipeline flow; the pipeline flow status parameters at boundary nodes of each area include: pressure, flux, temperature, flowing speed and density in the pipeline.

The process of the natural gas pipeline network simulation will be illustrated in detail by using the method for determining pipeline flow status parameters of natural gas pipeline network above with reference to specific embodiments, the process includes the following steps:

Step 1: “inputting information of natural gas pipeline network”, wherein the information of natural gas pipeline network includes topology structure of the natural gas pipeline network, parameters of each component and operating conditions thereof, etc.

Step 2: “dividing into a plurality of solving units (i.e. areas)”, specifically, dividing the natural gas pipeline network into a plurality of solving units according to topology structure of the natural gas pipeline network, for example, solving unit 1, . . . , solving unit i, . . . , solving unit M.

Step 3: analyzing and storing the information on topology structure of the solving unit i divided in Step 2, component parameters, etc., and establishing a first control equation representing operating status of natural gas in the pipeline of solving unit i.

Step 4: “processing the first control equation”, which mainly includes linearizing the first control equation, discretizing computation domain of the solving unit into subsections, and then discretizing the linearized first control equation on the discretized subsections as an algebraic equation set, i.e. transforming the control equation into mathematical equations which can be processed by a computer.

Step 5: “decomposing the first control equation”, specifically, solving the algebraic equation set of the “solving unit i”, to acquire fundamental solution system and general solutions of the algebraic equation set of the solving unit i, that is, this step is a process of decomposing coefficient matrices of the algebraic equations, which process is the core of natural gas pipeline network simulation, and is the most time consuming computation process.

Step 6: storing the fundamental solution system and the general solutions acquired by solving the algebraic equation set in Step 5.

Step 7: “acquiring linear relationship between pipeline flow status parameters at boundary nodes of the solving unit i and fundamental variables thereof”, specifically, analyzing the fundamental solution system of the solving unit i in Step 6, to acquire the linear relationship between the pipeline flow status parameters at boundary nodes of the solving unit i and the fundamental variables of the solving unit i, and thus establish a second control equation representing operating status of natural gas at the boundary nodes of the solving unit i, which second control equation can provide some of the equations for solving pipeline flow status parameters at boundary nodes of all solving units synchronously.

Step 8: “solving the fundamental variables”, specifically, solving the values of the fundamental variables of all solving units and thus solving the pipeline flow status parameters at boundary nodes of all the solving units at the same time, according to the linear relationship between pipeline flow status parameters at boundary nodes of all the solving units and fundamental variables of all the solving units, as acquired in Step 7, and according to the second control equations representing the operating status at the boundary nodes of all the solving units, wherein the boundary nodes are connection points between pipeline and component and between pipelines in the solving units.

Step 9: “solving inner nodes of the solving unit i”, specifically, combining the fundamental variables acquired in Step 8 with the fundamental solution system and the general solutions of the solving unit i acquired in Step 6, to directly acquire numerical solutions of pipeline flow status parameters of natural gas operating in the pipeline of the solving unit i, i.e. pipeline flow status parameters at the inner nodes of the solving unit I, wherein the inner nodes are connection points between the subsections divided when discretizing the computation domain of the solving unit.

Step 10: “solving the whole natural gas pipeline network, and showing the results”, specifically, accomplishing the work of the whole pipeline network simulation, and presenting the calculation results in the form of graph and data.

On the basis of the same inventive concept, embodiments of the present invention further provide an apparatus for determining pipeline flow status parameters of natural gas pipeline network, as described in the following embodiments. Since the apparatus for determining pipeline flow status parameters of natural gas pipeline network is based on the same theory as the method for determining pipeline flow status parameters of natural gas pipeline network, the implementation of the apparatus for determining pipeline flow status parameters of natural gas pipeline network can be referred to that of the method for determining pipeline flow status parameters of natural gas pipeline network, wherein the overlapping portions will not be repeated here. Terms “unit” or “module” used below can achieve a combination of software and/or hardware with predetermined functions. The apparatus described in the embodiments below will preferably be implemented by software, however, it is also possible and is conceived to implement by hardware or a combination of software and hardware.

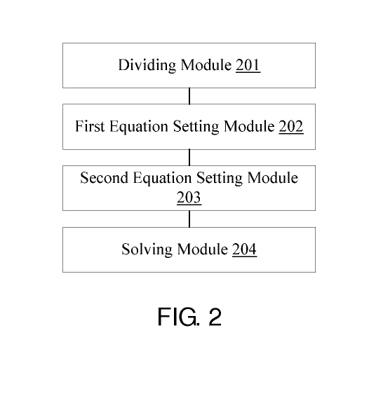

FIG. 2 is a schematic structural block diagram of an apparatus for determining pipeline flow status parameters of natural gas pipeline network according to an embodiment of the present invention. As shown in FIG. 2, the apparatus includes: a dividing module 201, a first equation establishing module 202, a second equation establishing module 203 and a solving module 204. These structures will be illustrated below.

The dividing module 201 is configured to divide a natural gas pipeline network into a plurality of areas according topology structure of the natural gas pipeline network;

The first equation establishing module 202 is connected with the dividing module 201, and is configured to, for each area, establish a first control equation representing the operating status in pipelines of the area, wherein unknown parameters of the first control equation are pipeline flow status parameters in pipelines of the area, and known parameters of the first control equation include structural parameters of pipelines, operating parameters of components and physical property parameters of natural gas;

The second equation establishing module 203 is connected with the first equation establishing module 202 and is configured to, for each area, establish a second control equation representing operating status at boundary nodes of the area, wherein the boundary nodes of the area are connection points of the area with adjacent areas in the natural gas pipeline network; and

The solving module 204 is connected with the second equation establishing module 203, and is configured to solve the first control equation and the second control equation, to determine the pipeline flow status parameters in the pipelines of each area and at the boundary nodes of each area.

In an embodiment, the apparatus further includes: a linearizing module, configured to linearize the first control equation for each area before solving the first control equation for each area; a discretizing module, connected with the linearizing module, and configured to discretize computation domain of each area into multiple sections and discretize the linearized first control equation for each area as an algebraic equation set on the discretized sections, wherein coefficient matrix of the algebraic equation set for each area is a matrix with a preset rule.

In an embodiment, the solving module 204 includes: a first unit, configured to solve the algebraic equation set for each area, and acquire fundamental solution system and general solutions of the algebraic equation set for each area; a linear analyzing unit, connected with the first unit, and is configured to, for each area, analyze fundamental solution system of the area, and acquire the linear relationship between pipeline flow status parameters at the boundary nodes of the area and fundamental variables of the area, wherein the boundary nodes of the area are connection points of the area with adjacent areas in the natural gas pipeline network, the fundamental variables of the area are variables represented by the coefficient that is multiplied when the fundamental solution system of the area representing the general solution of the area; a second unit, connected with the linear analyzing unit, and configured to calculate values of the fundamental variables of each area simultaneously by using the simultaneous second control equations of all areas and using the linear relationship between pipeline flow status parameters at boundary nodes of all areas and the corresponding fundamental variables, wherein the values of the fundamental variables for each area are determined as numerical solutions of pipeline flow status parameters at boundary nodes of the area; a third unit, connected with the second unit, and configured to determine the numerical solutions of pipeline flow status parameters in pipelines of each area according to the numerical solutions, the fundamental solution system and the general solutions of the fundamental variables for each area.

In an embodiment, the pipeline flow status parameters in pipelines of each area include: pressure and flux of the pipeline flow; or pressure, flux, temperature, flowing speed and density in the pipeline; the pipeline flow status parameters at boundary nodes of each area include: pressure, flux, temperature, flowing speed and density in the pipeline.

In embodiments of the present invention, the natural gas pipeline network is divided into a plurality of areas according to the topology structure of the natural gas pipeline network, and for each area, a first control equation independently representing the operating status of natural gas in pipelines of the area, and a second control equation representing the operating status at boundary nodes of the area are established, and then, the first and second control equations are solved, to determine the pipeline flow status parameters in pipelines of each area and the pipeline flow status parameters at boundary nodes of each area, and thus acquire the pipeline flow status parameters of the whole natural gas pipeline network. Through dividing the natural gas pipeline network into a plurality of areas, and for each area, establishing a second control equation representing operating status at boundary nodes of the area and a first control equation independently representing operating status in pipelines of the area, it is only necessary to solve all simultaneous second control equations (the number of unknown parameters is only 4 times of the number of the divided areas, which is much less than the unknown parameters of the first control equation for any area) during solving process, and the first control equations for each area can be solved independently, thereby achieving that, during solving process of the first and second control equations, only an algebraic equation set with a relative small number of algebraic equations needs to be solved after the control equations are discretized as the algebraic equation set. Therefore, the solving process on an algebraic equation set with a huge number of equations, when the natural gas pipeline network is regarded as a whole, is avoided. Meanwhile, the algebraic equation sets for areas are mutually independent and can be solved in parallel, thereby achieving a high efficient and rapid calculation of the pipeline flow status parameters of the natural gas pipeline network, which is simple and practicable and thus can improve the speed of the natural gas pipeline simulation.

Apparently, it should be understood by persons skilled in the art that, each of the above modules or steps of the embodiments of the present invention may be implemented by general purpose computing devices, and the modules or steps may be concentrated on a single computing device or distributed on a network formed by a plurality of computing devices. Optionally, the above modules or steps of the present invention may be implemented by computing device-executable program codes, so that they can be stored in storage devices to be executed by computing devices. In some cases, other sequences may be used to execute the shown or described steps. Additionally, above modules or steps may be implemented by respectively manufacturing them into various integrated circuit modules, or implemented by manufacturing a plurality of modules or steps selected from the modules or steps of the present invention into a single integrated circuit module. The embodiments of the present invention are not limited to any particular combination of hardware and software.

The above embodiments are merely preferred embodiments of the present invention and are not intended to limit the scope of the present invention. For those skilled in the art, the embodiments of the present invention may have multiple modifications and variations. Any modification, equivalent replacement, and improvement made without departing from the spirit and principle of the present invention shall fall within the protection scope of the present invention.

What is claimed is:

1. A method for determining pipeline flow status parameters of a natural gas pipeline network, comprising:
dividing the natural gas pipeline network into a plurality of areas according to topology structure of the natural gas pipeline network;
for each area, establishing a first control equation representing operating status in pipelines of the area, wherein unknown parameters of the first control equation are pipeline flow status parameters in the pipelines of the area, and known parameters of the first control equation include structural parameters of the pipelines, operating parameters of components and physical property parameters of the natural gas in the area;
for each area, establishing a second control equation representing operating status at boundary nodes of the area, wherein unknown parameters of the second control equation are pipeline flow status parameters at boundary nodes of the area, the boundary nodes of the area are connection points of the area connecting with adjacent areas in the natural gas pipeline network;
solving the first control equation and the second control equation, to determine the pipeline flow status parameters in the pipelines of each area and at the boundary nodes of each area.

2. The method for determining pipeline flow status parameters of a natural gas pipeline network according to claim 1, wherein, before solving the first control equation for each area, the method further comprises:
linearizing the first control equation for each area; and
discretizing a computation domain of each area into a plurality of sections, and discretizing the linearized first control equations for each area into an algebraic equation set on the sections, wherein a coefficient matrix of the algebraic equation set for each area is a matrix with a preset rule.

3. The method for determining pipeline flow status parameters of a natural gas pipeline network according to claim 2, wherein, solving the first control equation and the second control equation to determine the pipeline flow status parameters in the pipelines of each area and at the boundary nodes of each area, comprises:
solving the algebraic equation set for each area, to acquire a fundamental solution system and a general solution of the algebraic equation set for each area;
for each area, analyzing the fundamental solution system for the area, to acquire a linear relationship between the pipeline flow status parameters at the boundary nodes of the area and fundamental variables of the area, wherein, the fundamental variables of the area are variables represented by coefficients that are multiplied with the fundamental solution system of the area when the fundamental solution system of the area represents the general solution for the area;
calculating values of the fundamental variables of each area using the simultaneous second control equations of all areas, and using the linear relationship between pipeline flow status parameters at the boundary nodes and the fundamental variables of all areas, and determining the values of the fundamental variables for each area as numerical solutions of the pipeline flow status parameters at the boundary nodes of the area; and
determining numerical solutions of the pipeline flow status parameters in the pipelines of each area according to the numerical solutions of the fundamental variables, the fundamental solution system and the general solutions of each area.

4. The method for determining pipeline flow status parameters of a natural gas pipeline network according to claim 1, wherein,
the pipeline flow status parameters in the pipelines of each area comprise:
pressure, flux, temperature, flowing speed and density in the natural gas pipelines; and
the pipeline flow status parameters at the boundary nodes of each area comprise:
pressure, flux, temperature, flowing speed and density in the natural gas pipelines.

5. The method for determining pipeline flow status parameters of a natural gas pipeline network according to claim 2, wherein,
the pipeline flow status parameters in the pipelines of each area comprise:
pressure, flux, temperature, flowing speed and density in the natural gas pipelines; and
the pipeline flow status parameters at the boundary nodes of each area comprise:
pressure, flux, temperature, flowing speed and density in the natural gas pipelines.

6. The method for determining pipeline flow status parameters of a natural gas pipeline network according to claim 3, wherein,
the pipeline flow status parameters in the pipelines of each area comprise:
pressure, flux, temperature, flowing speed and density in the natural gas pipelines; and
the pipeline flow status parameters at the boundary nodes of each area comprise:
pressure, flux, temperature, flowing speed and density in the natural gas pipelines.

7. An apparatus for determining pipeline flow status parameters of a natural gas pipeline network, comprising:
a dividing module, configured to divide the natural gas pipeline network into a plurality of areas according to topology structure of the natural gas pipeline network;
a first equation establishing module, configured to, for each area, establish a first control equation representing operating status in pipelines of the area, wherein unknown parameters of the first control equation are pipeline flow status parameters in the pipelines of the area, and known parameters of the first control equation include structural parameters of the pipelines, operating parameters of components and physical property parameters of natural gas;
a second equation establishing module, configured to, for each area, establish a second control equation representing operating status at boundary nodes of the area, wherein unknown parameters of the second control equation are pipeline flow status parameters at the boundary nodes of the area, the boundary nodes of the area are connection points of the area connecting with adjacent areas in the natural gas pipeline network; and
a solving module, configured to solve the first control equation and the second control equation, to determine the pipeline flow status parameters in the pipelines of each area and at the boundary nodes of each area.

8. The apparatus for determining pipeline flow status parameters of a natural gas pipeline network according to claim 7, wherein, the apparatus further comprises:
a linearizing module, configured to linearize the first control equation of each area before solving the first control equation for each area; and
a discretizing module, configured to discretize a computation domain of each area into a plurality of sections, and discretize the linearized first control equations for each area into an algebraic equation set on the sections, a coefficient matrix of the algebraic equation set for each area is a matrix with a preset rule.

9. The apparatus for determining pipeline flow status parameters of a natural gas pipeline network according to claim 8, wherein, the solving module comprises:
a first unit, configured to solve the algebraic equation set of each area, to acquire a fundamental solution system and a general solution of the algebraic equation set for each area;
a linear analyzing unit, configured to, for each area, analyze the fundamental solution system for the area, and acquire a linear relationship between the pipeline flow status parameters at the boundary nodes of the area and fundamental variables for the area, wherein, the fundamental variables for the area are variables represented by coefficients that are multiplied with the fundamental solution system of the area when the fundamental solution system for the area represents the general solution for the area;
a second unit, configured to calculate values of the fundamental variables of each area using the simultaneous second control equations of all areas, and using the linear relationship between the pipeline flow status parameters at the boundary nodes and the fundamental variables of all areas, and determine the values of the fundamental variables of each area as numerical solutions of the pipeline flow status parameters at the boundary nodes of the area; and
a third unit, configured to determine the numerical solutions of the pipeline flow status parameters in the pipelines of each area according to the numerical solutions of the fundamental variables, the fundamental solution system and the general solutions of each area.

10. The apparatus for determining pipeline flow status parameters of a natural gas pipeline network according to claim 7, wherein,
the pipeline flow status parameters in the pipelines of each area comprise:
pressure, flux, temperature, flowing speed and density in the natural gas pipelines; and
the pipeline flow status parameters at the boundary nodes of each area comprise:
pressure, flux, temperature, flowing speed and density in the natural gas pipelines.

11. The apparatus for determining pipeline flow status parameters of a natural gas pipeline network according to claim 8, wherein,
the pipeline flow status parameters in the pipelines of each area comprise:
pressure, flux, temperature, flowing speed and density in the natural gas pipelines; and
the pipeline flow status parameters at the boundary nodes of each area comprise:
pressure, flux, temperature, flowing speed and density in the natural gas pipelines.

12. The apparatus for determining pipeline flow status parameters of a natural gas pipeline network according to claim 9, wherein,
the pipeline flow status parameters in the pipelines of each area comprise:
pressure, flux, temperature, flowing speed and density in the natural gas pipelines; and
the pipeline flow status parameters at the boundary nodes of each area comprise:
pressure, flux, temperature, flowing speed and density in the natural gas pipelines.
